(19) United States
(12) Patent Application Publication
(10) Pub. No.: US 2003/0008105 A1
(43) Pub. Date: Jan. 9, 2003

(54) Metal-plastic composite made from long-fiber-reinforced thermoplastics

(76) Inventors: Ulrich Haack, Alsbach (DE); Bernhard Pfeiffer, Wallbach (DE)

Correspondence Address: CONNOLLY BOVE LODGE & HUTZ, LLP, 1220 N MARKET STREET, P O BOX 2207, WILMINGTON, DE, 19899

(21) Appl. No.: 10/187,702

(22) Filed: Jul. 2, 2002

Related U.S. Application Data
(63) Continuation-in-part of application No. 09/761,313, filed on Jan. 17, 2001.

(30) Foreign Application Priority Data
Jan. 21, 2000 (DE) 10002642.7

(51) Int. Cl. B32B 15/08; B32B 3/10

(52) U.S. Cl. 428/136; 428/325; 428/425.8; 428/458; 428/463; 428/462; 428/139; 428/138

(57) ABSTRACT

The invention relates to metal-plastic composites in which the coefficients of thermal expansion of the plastic structures used are similar to those of the metals used, and whose strengths and stiffnesses are superior to those of purely metallic structures.

### RELATED APPLICATIONS

This application is a continuation-in-part of U.S. application Ser. No. 09/761,313 filed on Jan. 17, 2001 which is incorporated by reference in its entirety for all useful purposes. This application claims benefit to German Application No. 100 026 42.7 filed Jan. 21, 2000 which is incorporated by reference in its entirety for all useful purposes.

### BACKGROUND OF THE INVENTION

(1) Field of Invention

The present invention relates to a component made from long-fiber-reinforced thermoplastics and characterized by bonding between metal structures and plastic structures. The advance of automization in motor vehicle assembly makes it necessary, or at least highly desirable, that assemblies of rigid and movable parts can, where possible, themselves be put together and tested for correct functioning prior to their actual final installation into the motor vehicle as it is produced.

(2) Description of the Prior Art

Load-bearing structures used in vehicle construction and in industrial applications are usually composed of metals. In this connection it has been found that a considerable rise in stiffness and in strength can be brought about by using cross-ribbing, for example. A similar metal-plastic composite is described in EP 0 370 342 B1.

It is possible here to reduce the wall thickness for a given load, and thus to make a considerable saving in weight.

These load-bearing structures may serve as mounting supports (front end, door module, dashboard support). For this purpose, a high level of mechanical properties is required, and this level can be provided by metal-plastic composites. In addition, thermoplastically processable plastic gives the high degree of integration which allows low-cost design.

However, a disadvantage is that the coefficients of thermal expansion of the plastics used here differ from those of the metals. During processing, and during use in metal-plastic composites used over a wide temperature range, these differences cause internal stresses and distortion, which in turn reduce load-bearing capacity and accelerate material fatigue. These problems are indicated in lines 15-18, column 2 of EP 0 370 342 B1. The presence of the disadvantages described above could be deduced from the mention of the fact that the coefficient of thermal expansion of a metal-plastic composite is essentially determined by the metal.

DE 38 18 478 A1 describes a composite material comprising a metal layer and comprising a crosslinked polypropylene layer, fiber-reinforced with a glass fiber mat and having a coefficient of thermal expansion similar to that of the metal used. A disadvantage here is that injection molding is made difficult or impossible by the use of a glass fiber mat and by the crosslinking. The crosslinking also makes it impossible to recycle the plastic.

### BRIEF SUMMARY OF THE INVENTION

The object of the invention was to produce metal-plastic composites in which the coefficients of thermal expansion of the uncrosslinked plastic structures used are similar to those of the metals used, and whose strengths and stiffnesses are superior to those of purely metallic structures, while their weight is identical or lower.

Surprisingly, it has now been found that the coefficients of thermal expansion of long-fiber-reinforced thermoplastics are similar to those of steel, aluminum, and magnesium, and that the long-fiber-reinforced thermoplastics have less tendency to creep than short-fiber-reinforced thermoplastics. Using these materials it is possible to produce metal-plastic composites with strengths and stiffnesses superior to those given by purely metallic structures, and with weights below those of purely metallic structures.

### BRIEF DESCRIPTION OF THE FIGURES

FIG. 1 illustrates the percentage elongation against load duration.

FIG. 2 shows an embodiment of a metal plastic composite according to the invention.

FIG. 3 illustrates different ways of anchoring the plastic to the metal structure.

FIG. 4A to H illustrate the shape of such reinforcing structures.

FIG. 5A to F illustrate the cross sections of the metal structures.

FIG. 6 illustrates a possible embodiment of a snap connector.

### DETAILED DESCRIPTION OF THE INVENTION

The invention therefore provides a metal-plastic composite comprising at least one metal and comprising at least one long-fiber-reinforced thermoplastic whose coefficient of thermal expansion is similar to that of the metal used. The term long-fiber-reinforced thermoplastics is generally used for thermoplastics reinforced with fibers whose length is at least 1 mm and not more than 50 mm. The length of the fibers is preferably from 5 mm to 28 mm, more preferably from 8 mm to less than 25 mm and in particular from 8 mm to 20 mm, most preferably 8 to 12 mm. The length of the pellets and the length of the fibers are mostly identical in these materials. The reinforcing fiber is not restricted to a particular material. It is preferable here to use fibers made from materials with high melting points, for example glass fibers, carbon fibers, metal fibers, or aromatic polyamide fibers. The fibers within the pellets here may have been completely impregnated with the thermoplastic, or be in the form of a glass-fiber bundle coated by plastic.

Ribs made from material such as polypropylene are injected into metallic structures. Polypropylene was selected as the lowest-density plastic. The use of long fibers as reinforcing material allows coefficients of thermal expansion similar to those of metals, and low tendency to creep, to be achieved without any need to crosslink the thermoplastic used.

The mechanical properties of the long-fiber-reinforced thermoplastic are markedly superior to those given by short-fiber-reinforced thermoplastics.

Use of long-fiber-reinforced thermoplastics allows dramatic rises in strength and in stiffness to be achieved, together with a low tendency to creep and a coefficient of thermal expansion similar to that of metals.

The loading placed on the metal-plastic bonds in the metal-plastic composites described was so high that here again the advantages in strength and in stiffness over short-glass-fiber-reinforced thermoplastics were required in order to produce a component which could be subjected to high load.

The component according to the invention may generally be composed of metal structures of any desired metals, and is advantageously composed of iron or steel (including high-alloy or stainless), aluminum, magnesium or titanium.

To improve adhesion, the surface may advantageously have been provided with adhesion promoters, primers or surface coatings.

According to the invention, plastic materials which may be used are long-glass-fiber-reinforced or carbon-fiber-reinforced thermoplastics based on polyethylene, polypropylene, polyacetal, polyamide, polyester, polyphenylene oxide, polyphenylene sulfide, polyurethane, polycarbonate or polyester or acrylonitrile-butadiene-styrene copolymers or on acrylonitrile-styrene-acrylate graft polymers, or blends made from the plastics mentioned. Particular polyesters which may be used are polyethylene terephthalate or polybutylene terephthalate.

Plastic materials which may be used, besides freshly produced materials, are first-, second- or higher-generation recycled materials, or mixtures made from freshly produced material with recycled materials. Mixtures of this type may, if desired, also comprise additives, or may have been modified by admixture of other compatible polymers. There is no need for crosslinkers to be added in order to achieve the advantages of the invention.

Besides the long reinforcing fibers, the plastic material may also comprise other conventional additives and reinforcing materials, for example other fibers, in particular metal fibers, or mineral fibers, processing aids, polymeric lubricants, ultra high-molecular-weight polyethylene (UHMWPE), polytetrafluoroethylene (PTFE), or graft copolymer, which is a product from a graft reaction, made from an olefin polymer and from an acrylonitrile-styrene copolymer, antioxidants, adhesion promoters, nucleating agents, mold-release aids, glass beads, mineral fillers, such as chalk, calcium carbonate, wollastonite, silicon dioxide, talc, mica, montmorillonite, organically modified or unmodified, organically modified or unmodified phyllosilicates, materials which form nanocomposites with the plastic, nylon nanocomposites, or mixtures of the substances mentioned.

The coefficient of thermal expansion is similar to that of a metal if it does not deviate by more than 20×10⁻⁶K⁻¹ from the coefficient of thermal expansion of the metal used.

The coefficients of thermal expansion of long-glass-fiber reinforced thermoplastics are similar to those of steel, aluminum and magnesium (Table 1).

TABLE 1
Coefficients of thermal expansion of long-fiber-
reinforced thermoplastics (from −30° C. to +30° C.) ; PP-
polypropylene, PA-polyamide, PET-polyethylene terephthalate,
PBT-polybutylene terephthalate, PPS-polyphenylene sulfide,
PC/ABS-polycarbonate-ABS-blend, TPU-thermoplastic polyurethane
elastomer, GF-glass fiber, cf-carbon fiber

| Material | Coefficient of thermal |
|---|---|
| (Plastic-Fiber, Amount of | expansion |
| fiber/weight %) | 10⁻⁶ K⁻¹ |
| PP-GF 30 | 16 |
| PP-GF 40 | 15 |
| PP-GF 50 | 13 |
| PA66-GF 40 | 19 |
| PA66-GF 50 | 17 |
| PA66-GF 60 | 15 |
| PA66-CF 40 | 13 |
| PET-GF 40 | 16 |
| PET-GF 40 | 19 |
| PPS-GF 50 | 12 |
| PC/ABS-GF 40 | 18 |
| TPU-GF 40 | 13 |
| TPU-GF 50 | 10 |
| TPU-CF 40 | 18 |
| Comparison with metals | |
| Iron | 12.2 |
| Steel | 12 |
| Magnesium | 26 |
| Aluminum | 22 |
| Comparison with | |
| unreinforced plastics | |
| Unreinforced PP | 83 |
| Unreinforced PA66 | 90 |

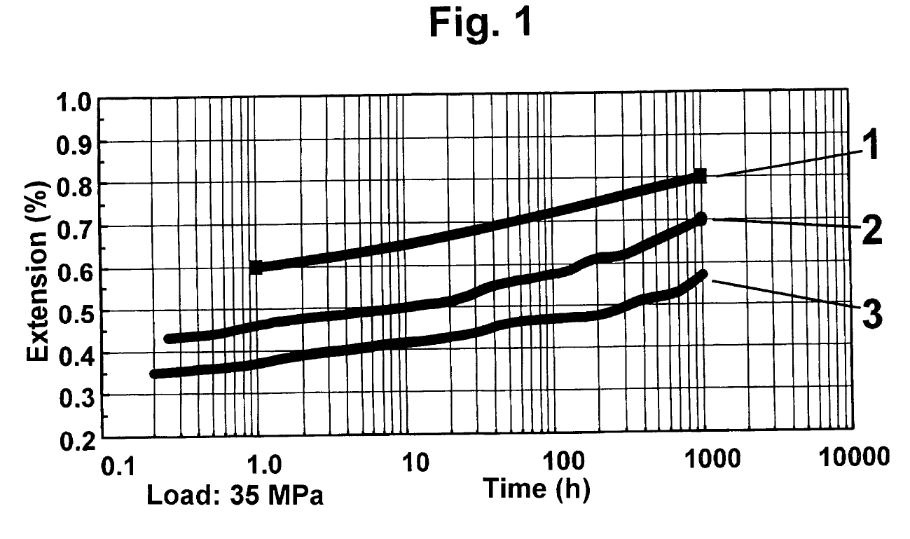

Long-fiber-reinforced thermoplastics also have a lower tendency to creep than short-fiber-reinforced thermoplastics. The invention is further illustrated by FIG. 1. FIG. 1 plots the percentage elongation against load duration. Curve 1 shows the creep performance of a short-glass-fiber-reinforced nylon-6,6 with a proportion of 30% of glass fibers, and curves 2 and 3 show the creep performance of long-glass-fiber-reinforced polypropylene with a proportion of 40% and 50% of glass fibers.

The creep performance and coefficients of thermal expansion of long-glass-fiber-reinforced thermoplastics make them particularly suitable for use in metal-plastic composites used over a wide temperature range, as is the case in the automotive industry, for example (from −40 to +120° C.).

The plastic structures may be produced by thermoplastic processing methods, preferably by conventional techniques, such as injection molding, thermoforming, hot-press molding, injection-compression molding, low-pressure injection molding or blow molding. Such techniques are, for example, described Saechtling, Kunststoff-Taschenbuch [Plastics handbook] 27th edition 1998, Hanser-Verlag. In general, a metal structure is obtained in a way generally known, inserted into a mold, for example an injection mold, and in the appropriate way for the technique employed the plastic structure is being formed. In a preferred embodiment the metal structure is inserted into the mold, press-formed and in a further step the plastic structure is injected to for the plastic structure.

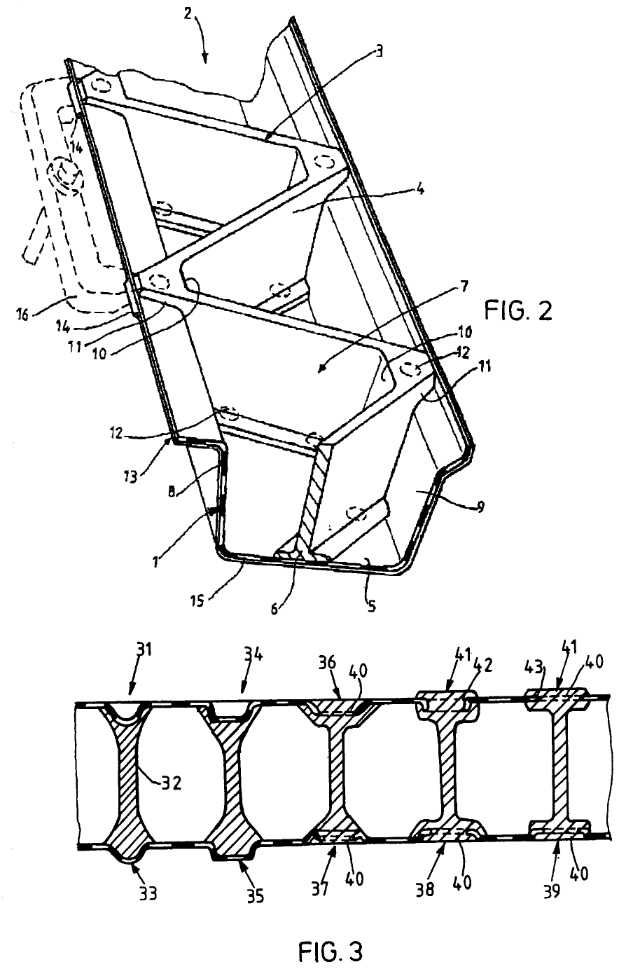

FIG. 2 shows another embodiment of a metal plastic composite according to the invention. It comprises a U-shaped metal structure 1, preferably made of steel, in its interior 2 V-shaped reinforcement ribs 3 made of long-fiber reinforced polypropylene reinforced with glass fibers having a fiber length of about 15 mm. The ribs contain a bridge 4 ranging through the entire interior 2 down to the bottom 5 of the U-shaped metal structure 1, showing a broadened foot 6. The ribs 3 together with the metal structure 1 form trapezoid spaces 7, the side walls 8 and 9 of the metal structure 1 have connection bridges 10 made from the same thermoplastic material. Said connection bridges are parallel to the side walls 8 and 9 and are fixed thereto. They show about the same thickness as the ribs 3. Between ribs 3 and metal structure 1 are shown in broken lines anchors in the shape of, for example, holes, apertures, undercuts or break-throughs 12, through which the plastic extends from the inside to the outside of the metal structure 13 forming binding block 14. The outside 13 may be covered with a cover layer of the same plastic 15. For demonstration of the injeciton molding technique the channel of an injection mold 16 is depicted in broken line.

In FIG. 3, different ways of anchoring the plastic to the metal structure are shown. 31 is a way of anchoring where the plastic does not extend through a hole in the metal structure but is linked to two half-circular deformations of the metal.

One of the deformations 31 is pointing into the rib 32, the other 33 to pointing away from the rib. Anchors 34 and 35 have a rectangular shape. The anchors 36, 37, 38 and 39 essentially have a rectangular shape, but additionially have apertures 40. The anchor 41 contains an aperture with the edge being deformed to a rectangular cross-section 42. The anchor 43 shows just an aperture.

According to the invention, there are two different ways of producing the metal-plastic bonding. The first method uses one of the thermoplastic processing methods to bring about bonding within the metal structure.

The bonding is preferably produced by interlocking, under-cutting (e.g. by using a dovetail shape) or penetration through an aperture or slot, where a plug is produced on the reverse side of the aperture and cannot be pulled back through the aperture without being destroyed. In the second possibility, the metal-plastic bonding is brought about by introducing elevations of peg-like or other shape on the plastic part into openings in the metal structure, for example apertures or slots. A permanent connection is produced advantageously by subsequent heat welding, bending or thermal deformation.

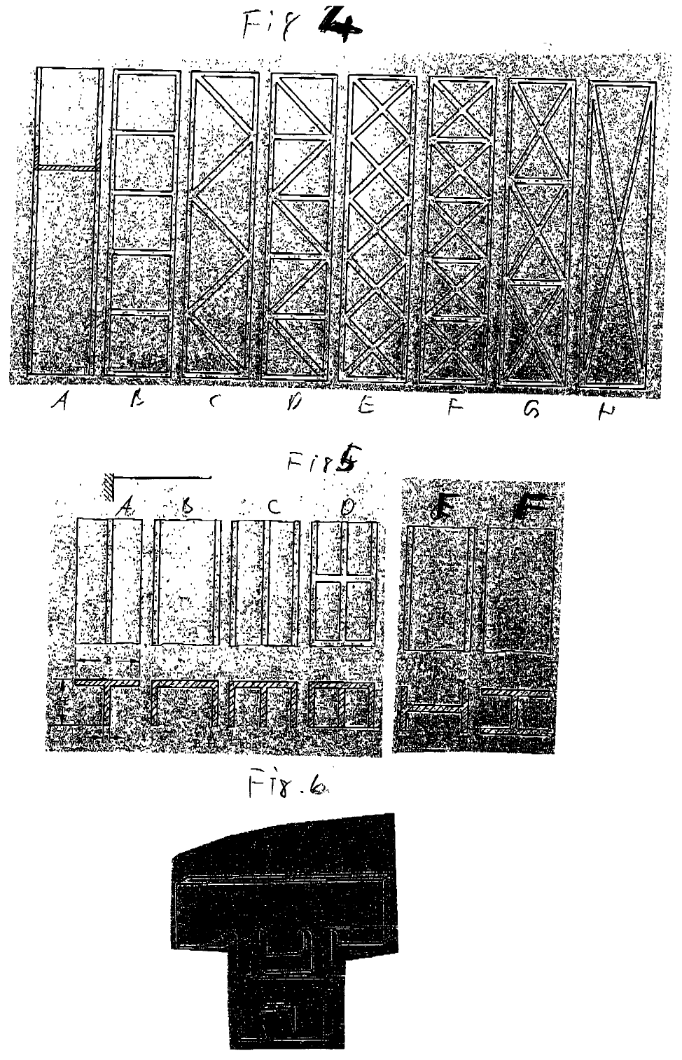

The cross sections of the metal structures are not linear, but shaped and may, for example, have cross sections in the shape of a U, V or W or a metal hollow body like a tube hving, for example, a circular or rectangular cross section. Further cross sections are known and depicted in FIG. 5A to F.

Within these metal structures, the shapes of the plastics may be as desired, but shaped in order to improve the mechanical stability of the metal structure, for example in the shape of ribs, honeycombs, rectangular, or a combination thereof, but may also include sheet-like layers. Such reinforcing structures have to contain at least one layer which is not parallel, but orthogonal to the surface 33 of the metal structure.

The shape of such reinforcing structures are schematically depicted, but not limited to FIG. 4A to H. In order to provide for structural reinforcement, the plastic structure has to be connected to the metal structure as described above.

The plastics may have been provided with functional parts, such as housings or housing sections, snap connectors or film hinges. As an example, a possible embodiment of a snap connector is shown in FIG. 6. Since abrasion performance with respect to plasatic and metal is good, the functional parts may also be sliding surfaces. These plastic structures preferably have the shape of ribs as depicted in FIG. 3A to H or the shape of honeycombs.

The metal-plastic composites according to the invention may be advantageously used for motor vehicle doors, frontends, frames for machinery or the like.

All the references mentioned herein are incorporated by reference in its entirety for all useful purposes.

1. A metal-plastic composite comprising at least one metal has a surface and optionally an opening and comprising at least one uncrosslinked long-fiber-reinforced thermoplastic whose coefficient of thermal expansion is similar to that of the metal used wherein said thermoplastic is bonded to at least a part of said surface of said metal or in said opening of said metal in order to provide added structural support.

2. The metal-plastic composite as claimed in claim 1, wherein the plastic used comprises polyethylene, polypropylene, polyamide, polyacetal, polyester, polyphenylene oxide, poly-phenylene sulfide, polyurethane, polycarbonate, polyester, acrylonitrile-butadiene-styrene copolymers or acrylonitrile-styrene-acrylate graft polymers, polyethylene terephthalate or polybutylene terephthalate, or comprising a mixture made from at least two of these plastics.

3. The metal-plastic composite as claimed in claim 1, wherein the fibers present in the plastic comprise glass fibers, carbon fibers, metal fibers or aromatic polyamide fibers.

4. The metal-plastic composite as claimed in claim 1, wherein the length of the polymer pellets used for the production process and the length of the reinforcing fiber are identical.

5. The metal-plastic composite as claimed in claim 1, wherein the metal used comprises iron, steel, aluminum, magnesium, or titanium.

6. A process for producing a metal-plastic composite as claimed in claim 1, in which the coefficient of thermal expansion of the plastic is similar to that of the metal used, the plastic used being a thermoplastic reinforced with fibers of length from 0.5 mm to 50 mm.

7. The metal-plastic composite as claimed in claim 1, obtained by thermoplastic processing methods.

8. The metal-plastic composite as claimed in claim 7, wherein said thermoplastic processing methods are selected from the group consisting of injection molding, thermoforming, hot-press molding, injection-compression molding, low-pressure injection molding and blow molding.

9. The metal-plastic composite as claimed in claim 1, wherein said metal has a cross section having a shape of a U, V or W.

10. The metal-plastic composite as claimed in claim 9, wherein said metal has an opening which has a slot or aperture and said thermoplastic is bonded in said slot or aperture.

11. The metal-plastic composite as claimed in claim 10, wherein said thermoplastic cannot be pulled back through the plug or aperture without being destroyed.

12. A process for producing a metal-plastic composite as claimed in claim 1, which comprises bonding said thermoplastic into an opening in said metal or on part of the surface of said metal by thermoplastic processing methods, the plastic used being a thermoplastic reinforced with fibers of length from 5 mm to 28 mm.

13. The process as claimed in claim 12, wherein said opening has an aperture or slot.

14. The process according to claim 12, wherein said bonding is conducted by heat welding or thermo deformation.

15. The process as claimed in claim 12, wherein said thermoplastic processing methods are selected from the group consisting of injection molding, thermoforming, hot-press molding, injection-compression molding, low-pressure injection molding and blow molding.

16. A metal-plastic composite comprising at least one metal and comprising at least one uncrosslinked long-fiber-reinforced thermoplastic whose coefficient of thermal expansion is similar to that of the metal used and said fiber has a length from 5 to 28 mm.

17. The composite as claimed in claim 16, wherein said fiber has a length from 8 to 20 mm.

18. The composite as claimed in claim 16, wherein said fiber has a length from 8 to 12 mm.
